(19) United States
(12) Patent Application Publication
(10) Pub. No.: US 2025/0346241 A1
(43) Pub. Date: Nov. 13, 2025

(54) METHOD FOR OPERATING A VEHICLE CENTRAL COMPUTER

(71) Applicant: Robert Bosch GmbH, Stuttgart (DE)

(72) Inventors: Abel Eckart, Leingarten (DE); Christoph Diekmann, Besigheim (DE)

(21) Appl. No.: 18/871,167

(22) PCT Filed: Jun. 5, 2023
(86) PCT No.: PCT/EP2023/064994

§ 371 Date: Dec. 3, 2024

(30) Foreign Application Priority Data
Jul. 6, 2022 (DE) 10 2022 206 894.7

(51) Int. Cl. B60W 50/08; B60W 30/18; B60W 50/00

(52) U.S. Cl. CPC B60W 50/085; B60W 30/18; B60W 2050/0014; B60W 2050/0031; B60W 2540/215

(57) ABSTRACT

A method for operating a vehicle central computer for controlling one or more actuators of a vehicle. A specification module and a control module are implemented in the vehicle central computer. The specification module provides a parameterizable target behavior for controlling the one or more actuators. The target behavior is passed from the specification module to the control module via an internal interface. The control module determines and provides, in particular outputs, control variables for the one or more actuators based on the target behavior and within the framework of a control.

### FIELD

The present invention relates to a method for operating a vehicle central computer as well as a computing unit and a computer program for carrying out said method.

### BACKGROUND INFORMATION

Traditionally, a variety of control units are used in vehicles for different functions, such as vehicle dynamics, drive and the like, and are typically each designed for a specific task. In modern vehicles, so-called vehicle central computers are being used more and more frequently as well. These are particularly powerful computing units that can perform a variety of tasks and are sometimes intended or able to replace several individual conventional control units.

### SUMMARY

According to the present invention, a method for operating a vehicle central computer as well as a computing unit and a computer program for carrying out the method are provided. Advantageous example embodiments of the present invention are disclosed herein.

The present invention relates to vehicle central computers which are used to control one or, particularly preferably, several actuators of a vehicle and are also configured for this purpose, and the operation of said vehicle central computers. As mentioned, a vehicle central computer is a particularly powerful computing unit, which can, for instance, perform a variety of tasks, and can, for instance, also replace several individual conventional control units. Depending on the type of vehicle and the number and type of actuators used there, only one such vehicle central computer may be provided in the vehicle, for example, but several such vehicle central computers is possible, too. It is also possible to use the terms “central control unit” or “domain control unit” instead of “vehicle central computer”.

In particular the functionalities (functional components) needed for the various actuators can be implemented in a vehicle central computer, which leads in particular to a reduction in the complexity of the actuators themselves. In particular in the case of a vehicle central computer that can control multiple actuators, e.g., the actuators of a domain such as vehicle dynamics, improvements in performance can be achieved by combining several controller parts of several actuators. Abstracting the actuators from the driving or vehicle dynamics system also makes it possible to standardize development. Variant handling and hardware characteristics can be handled separately from function development. The vehicle dynamics domain comprises actuators such as an integrated brake system, an electronic steering device, an inverter of an electric machine, a chassis actuator and the like. Other examples of actuators include active stabilizers, limited-slip differentials, all-wheel clutches, axle or wheel drives.

In the context of the present invention, it is provided that a specification module and a control module (software modules) be implemented in the vehicle central computer. The specification module provides a target behavior for the vehicle (vehicle target behavior), which is then put into effect by controlling the one or more actuators. According to an example embodiment of the present invention, the vehicle target behavior is in particular reduced to basic vehicle characteristics. This ensures that any vehicle target behavior can be implemented with the existing actuators (i.e. the available actuators) and is independent of the installed actuators. The specific requirements of today's vehicles should be met, however. For instance, a yaw moment actuator is needed to implement vehicle dynamics control. In terms of control technology, it should be possible to control the states. A basic vehicle target behavior for the vehicle is thus defined there, e.g. a vehicle dynamics target behavior, but, for example, without having to have knowledge of the specific control of the actuators to be controlled.

The specification module can in particular be designed such that it provides a user interface, e.g. a graphical user interface, possibly by interacting with an input and display means. A user, in particular a vehicle manufacturer (OEM) or an employee there, can thus specify or define the vehicle target behavior for a particular vehicle or type of vehicle.

The vehicle target behavior is or will be specified in particular by vehicle movement parameters such as, vehicle ground speed, vehicle acceleration, yaw rate, yaw acceleration, sideslip angle, sideslip angle speed, body path speed and body path acceleration. Overall, therefore, by general states of a single or two-track model and their derivatives. The vehicle target behavior is thus highly abstracted from the actual control behavior; e.g. the vehicle target behavior can also simply include that the vehicle should oversteer quickly or be particularly dynamic.

According to an example embodiment of the present invention, an interface from the control module to the actuators then includes general options for influencing the vehicle dynamics, for instance; e.g. braking via the individual wheel torque, steering via the steering angle, chassis via the normal force distribution and the like.

Such a parameterization of the control behavior in particular takes place outside of regular operation of the vehicle central computer, i.e. offline. The vehicle central computer is thus configured accordingly or is operated accordingly.

This vehicle target behavior is then passed from the specification module to the control module via an internal interface (internally in the vehicle central computer or the software running on it). This can also be accomplished by having the control module access the specification module or the vehicle target behavior available there as needed, for instance; in particular by reading out the needed data from there.

A control behavior for the actuators is then determined based on this vehicle target behavior, e.g. by parameterization. This control behavior can therefore, for example, be parameterized; i.e. adapted or even fundamentally specified. This can be done in the control module. This control behavior then in particular also includes target variables or target value for the control itself. The (specific) control behavior is thus determined from the (abstract) vehicle target behavior; e.g., known control behaviors can be used for a desired dynamic behavior of the vehicle and adapted if necessary.

Control variables for the one or more actuators are then determined and provided, in particular output, in the control module based on the control behavior and within the framework of a control. The actuators can be controlled or operated with these control variables (e.g. the torque to be set, etc.). Like a conventional control, this control can then obtain target values for certain control or control variables (as input variables), e.g. from a driver or driver assistance system, during operation of the vehicle which are then adjusted accordingly. Such input variables could generally be obtained from all of the input methods that a user/driver can communicate to the vehicle, for example: steering wheel, accelerator pedal, brake pedal, gear selector lever, sport mode shifter, joystick, comfort setting and the like.

However, these target values for the actual control are in themselves independent of the generally specified vehicle target behavior. The control in particular also takes place chronologically after and independently of the provision of the vehicle target behavior.

While the basic vehicle target behavior can be defined or specified via the specification module, e.g. a basic specification of how the vehicle should react, e.g. how quickly a brake or steering system should respond, the specific control behavior is then in particular set in relation to the specifically available actuators and the actual control then takes place in the control module which is separate from the specification module. Thus, for instance, one or more control strategies intended for the one or more actuators are stored in the control module. Such control strategies can in particular be (or have been) specified and possibly adjusted by an actuator manufacturer (e.g. supplier) or an employee there, who in particular also has special know-how of the actuators to be controlled. Such control strategies can, for example, define what type of controller is used when and where and with which parameters. Thus, whereas the functions carried out by the control module are comparable to conventional control units, for example, the specification module also allows the basic vehicle target behavior to be defined by users other than the manufacturer, which has to date not been possible in this way.

According to an example embodiment of the present invention, it is particularly preferred if the control module is implemented such that changes in the control module (e.g. in the control strategies) cannot be made from the outside, in particular neither directly nor via the specification module. It is possible that the control module is instead implemented such that changes in the control module can be made from the outside only with authorization (e.g. by entering a specific code or the like). The basic vehicle target behavior can thus be specified from the outside, typically by a vehicle manufacturer. However, the specific implementation and/or the actual control of the actuators as well as the specific control behavior cannot be changed by the vehicle manufacturer-not even unintentionally. Rather, the specific implementation is left to the supplier with his special know-how. This also avoids poorly designed controllers, for example.

According to an example embodiment of the present invention, an adaptation or adjustment of the control carried out or to be carried out in the control module (control strategies or control behavior), on the other hand, can preferably take place during regular operation of the vehicle central computer, i.e. online, in particular by means of an observer and/or a learning algorithm (e.g. also via machine learning methods, for instance with an artificial neural network). The vehicle central computer is thus configured accordingly or is operated accordingly. The control or the control behavior can thus be continuously improved, regardless of any specifications for the vehicle target behavior.

A computing unit according to the present invention, e.g., a vehicle central computer of a motor vehicle, is configured, in particular in terms of programming, to carry out a method according to the invention.

The implementation of a method according to the present invention in the form of a computer program or computer program product comprising program code for carrying out all method steps is advantageous as well, because the associated costs are very low, in particular if an executing control unit is also used for other tasks and is therefore already available. Lastly, a machine-readable storage medium is provided, on which the computer program is stored as described above. Suitable storage media or data carriers for providing the computer program are in particular magnetic, optical and electrical memories, such as hard drives, flash memories, EEPROMs, DVDs, etc. Downloading a program via computer networks (Internet, intranet, etc.) is possible, too. Such a download can be wired or cabled or wireless (e.g. via a WLAN, a 3G, 4G, 5G or 6G connection, etc.).

Further advantages and embodiments of the present invention will emerge from the description and the figures.

The present invention is shown schematically in the figures on the basis of an embodiment example and is described in detail in the following with reference to the figures.

### BRIEF DESCRIPTION OF THE DRAWINGS

FIG. 1 schematically shows a vehicle comprising a vehicle central computer and multiple actuators in which the present invention can be used.

FIG. 2 schematically shows a modular illustration of a vehicle central computer to explain a method according to the present invention in a preferred embodiment.

### DETAILED DESCRIPTION OF EXAMPLE EMBODIMENTS

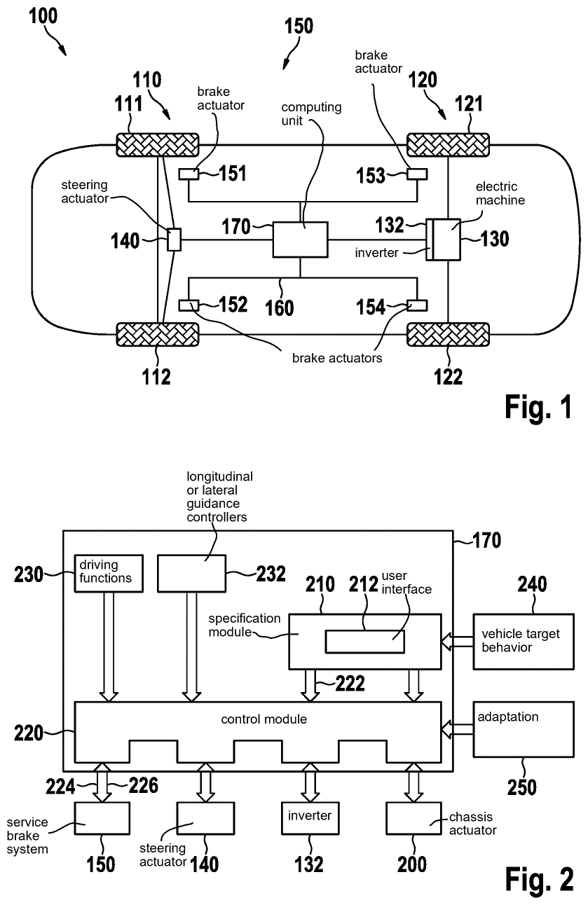

FIG. 1 schematically shows a vehicle 100 comprising a computing unit 170 configured as a vehicle central computer and multiple actuators in which the invention can be used. A front axle 110 with wheels 111, 112 and a rear axle 120 with wheels 121, 122 of the vehicle 100 are shown as an example. An electronic steering device (steering actuator) 140 is provided for the front axle 110, and an electric machine 130 with inverter 132 is provided for the rear axle to drive and, if necessary, brake the vehicle.

A service brake system 150 with four brake actuators 151-154, one for each wheel, is provided as well. All of these actuators are used for vehicle dynamics control and are intended to be connected to the vehicle central computer 170 via a communication system 160 (e.g. a data bus), for example. Output stages or the like for the energetic control of the actuators can optionally be provided in the vehicle central computer or, typically, elsewhere.

The vehicle central computer 170 is intended to be able to control or operate the aforementioned actuators (or systems) during operation of the vehicle 100, for instance. The vehicle central computer 170 can obtain driving instructions from a driver and/or a driver assistance system (target values), which are then implemented within the framework of a control using the vehicle central computer 170, the control module there. The control is in the context of a control behavior that is based on a specified vehicle target behavior.

FIG. 2 schematically shows a modular illustration of a vehicle central computer to explain a method according to the invention in a preferred embodiment. This is the vehicle central computer 170 of FIG. 1, for instance, which is used to control the brake system 150, the electronic steering device 140 and the inverter 132 of the electric machine, in each case as in FIG. 1, as well as another example chassis actuator 200.

It goes without saying that further actuators, in particular vehicle dynamics actuators, etc., can be controlled by means of the vehicle central computer 170 as well. Such a vehicle central computer can in principle also be used for actuators other than vehicle dynamics actuators; the vehicle dynamics actuators are used here in particular as an example for explanation.

Software with a specification module 210 and a control module 220 is implemented in the vehicle central computer 170. These two modules, the specification module 210 and the control module 220, are intrinsically separate from one another; there is only an interface 222 to pass or transmit certain data from the specification module 210 to the control module 220 as will be explained in the following.

A vehicle target behavior 240 is provided or obtained by the specification module 210. This can be accomplished via a user interface 212 provided by the specification module 210, for instance, e.g. a graphical user interface (so-called GUI). If the vehicle central computer 170 has an appropriate data-transmitting connection to an external computer system, this graphical user interface can be shown or provided to said external computer system, for example on its display means.

This is preferably carried out offline, e.g. initially before the vehicle is put in operation for the first time or possibly in the context of updates, but not during regular operation. The vehicle target behavior of the vehicle can thus be defined, at least to the extent that said behavior can be influenced by the control of the relevant actuators.

This specified vehicle target behavior is then passed from the specification module 210 to the control module 220 via the internal interface 222. It is also possible that the vehicle target behavior is or will be stored for this purpose in a memory to which the control module also has access. There, i.e. in the control module 220, control variables 224 (e.g. torques to be set) for the actuators are determined and provided, in particular output to them, based on the vehicle target behavior and within the framework of a control. Actual values 226 can in turn be obtained from the actuators—or from suitable sensors. Therefore, during regular operation of the vehicle, only the control module 220 is active, whereas the specification module 210 is not only not required, but should in particular also not be able to intervene in the control.

The control behavior is also influenced by how an input by a driver (e.g. a brake or steering actuation, or accelerator pedal) is to be carried out, for example. The control behavior (in particular target values) can therefore be specified; for example by driving functions 230 or longitudinal and lateral guidance controllers for assisted and automated driving functions 232, e.g., axle and yaw rate controllers for stationary stable driving situations.

During regular operation of the vehicle, on the other hand, an adaptation 250 of the control carried out or to be carried out in the control module can take place, for example, in particular by means of an observer and/or a learning algorithm. The specific control can thus be continuously improved without undermining the general target behavior.

This adaptation can, for instance, be carried out using online learning models to determine the current vehicle state with the help of extended/unscented Kalman filters for parallel state and parameter estimation. Other options include neural networks with offline training and online estimation. Neural networks, for example, have the advantage that they map nonlinearities better. Kalman filters/observers, on the other hand, are always “forced” onto physical correlations. A suitable approach can be chosen depending on the controller design.

1-12. (canceled)

13. A method for operating a vehicle central computer for controlling one or more actuators of a vehicle, wherein a specification module and a control module are implemented in the vehicle central computer, the method comprising:
obtaining a vehicle target behavior from the specification module;
passing the vehicle target behavior from the specification module to the control module via an internal interface;
determining a control behavior of the one or more actuators based on the vehicle target behavior; and
determining and providing, by the control module, outputs including control variables for the one or more actuators based on the control behavior and within the framework of a control.

14. The method according to claim 13, wherein the vehicle target behavior is specified based on a single-track model or a two-track model of the vehicle.

15. The method according to claim 13, wherein the control takes place chronologically after and independently of providing of the vehicle target behavior.

16. The method according to claim 13, wherein the specification module is implemented such that it provides a user interface for obtaining or inputting the vehicle target behavior.

17. The method according to claim 13, wherein the vehicle central computer is configured such that a control behavior for controlling the one or more actuators can be determined or parameterized outside of regular operation of the vehicle central computer.

18. The method according to claim 13, wherein the vehicle central computer is configured such that the control carried out or to be carried out in the control module is adapted during regular operation of the vehicle central computer, via an observer and/or a learning algorithm.

19. The method according to claim 13, wherein the control module is implemented such that changes in the control module cannot be made from outside, neither directly nor via the specification module.

20. The method according to claim 13, wherein the control module is implemented such that changes in the control module can be made from the outside only with authorization.

21. The method according to claim 13, wherein the one or more actuators are one or more of the following vehicle dynamics actuators: (i) an integrated brake system, (ii) an electronic steering device, (iii) an inverter of an electric machine, (iv) an active stabilizer, (v) a limited-slip differential, (vi) an all-wheel clutch, (vii) an axle or wheel drive, (viii) a chassis actuator.

22. A computing unit for operating a vehicle central computer for controlling one or more actuators of a vehicle, wherein a specification module and a control module are implemented in the vehicle central computer, the computing unit configured to perform the following steps:
obtaining a vehicle target behavior from the specification module;
passing the vehicle target behavior from the specification module to the control module via an internal interface;
determining a control behavior of the one or more actuators based on the vehicle target behavior; and
determining and providing, by the control module, outputs including control variables for the one or more actuators based on the control behavior and within the framework of a control.

23. A non-transitory machine-readable storage medium on which is stored a computer program for operating a vehicle central computer for controlling one or more actuators of a vehicle, wherein a specification module and a control module are implemented in the vehicle central computer, the computer program, when executed by a computer, causing the computer to perform the following steps:
obtaining a vehicle target behavior from the specification module;
passing the vehicle target behavior from the specification module to the control module via an internal interface;
determining a control behavior of the one or more actuators based on the vehicle target behavior; and
determining and providing, by the control module, outputs including control variables for the one or more actuators based on the control behavior and within the framework of a control.
